(19) United States
(12) Patent Application Publication
(10) Pub. No.: US 2025/0365760 A1
(43) Pub. Date: Nov. 27, 2025

(54) METHODS AND APPARATUSES FOR S-SSB TRANSMISSION IN UNLICENSED SPECTRUM

(71) Applicant: LENOVO (BEIJING) LIMITED, Beijing (CN)

(72) Inventors: Xin Guo, Beijing (CN); Haipeng Lei, Beijing (CN); Zhennian Sun, Beijing (CN); Xiaodong Yu, Beijing (CN)

(21) Appl. No.: 18/865,372

(22) PCT Filed: May 14, 2022
(86) PCT No.: PCT/CN2022/092905

§ 371 Date: Nov. 13, 2024

(51) Int. Cl. H04W 74/0808; H04W 16/14; H04W 92/18

(52) U.S. Cl. CPC H04W 74/0808; H04W 16/14; H04W 92/18

(57) ABSTRACT

The present disclosure relates to methods and apparatuses for sidelink synchronization signal block (S-SSB) transmission in an unlicensed spectrum. One embodiment of the present disclosure provides a UE, comprising: a transceiver; and a processor coupled with the transceiver and configured to: obtain a first configuration for S-SSB in an unlicensed spectrum based on configuration or pre-configuration, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB; select at least one S-SSB occasion at least based on the first configuration; and transmit, with the transceiver, an S-SSB on the at least one S-SSB occasion in response to a LBT procedure associated with the at least one S-SSB occasion being successful.

### TECHNICAL FIELD

The present disclosure relates to wireless communication technology, and more particularly, to methods and apparatuses for sidelink (SL) synchronization signal block (SSB) transmission in an unlicensed spectrum.

### BACKGROUND OF THE INVENTION

A sidelink is a long-term evolution (LTE) feature introduced in 3^{rd} generation partnership project (3GPP) Release 12, and enables a direct communication between proximal user equipments (UEs), in which data does not need to go through a BS or a core network. A sidelink communication system has been introduced into 3GPP 5G wireless communication technology, in which a direct link between two UEs is called a sidelink.

Sidelink synchronization information is carried in an SL SSB (i.e. S-SSB). In an unlicensed spectrum, the S-SSB transmission needs to meet requirements such as the occupied channel bandwidth (OCB) requirement, the listen-before-talk (LBT) requirement, etc. Therefore, new designs for S-SSB transmission in an unlicensed spectrum are needed.

### SUMMARY

One embodiment of the present disclosure provides a UE, comprising: a transceiver; and a processor coupled with the transceiver and configured to: obtain a first configuration for S-SSB in an unlicensed spectrum based on configuration or pre-configuration, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB; select at least one S-SSB occasion at least based on the first configuration; and transmit, with the transceiver, an S-SSB on the at least one S-SSB occasion in response to a LBT procedure associated with the at least one S-SSB occasion being successful.

In some embodiments, the first configuration includes a first structure configuration in the frequency domain of a symbol of the at least one symbol of each S-SSB, and the first structure configuration includes at least one of the followings: at least one PSBCH repetition, location of each one of the at least one PSBCH repetition, at least one SLSS repetition, location of each one of the at least one SLSS repetition, at least one resource block (RB) unoccupied by the at least one PSBCH repetition and/or the at least one SLSS repetition, or location of each one of the at least one RB in the frequency band.

In some embodiments, one SLSS repetition of the at least one of SLSS repetition is at or close to an edge of the S-SSB in the frequency domain.

In some embodiments, one PSBCH repetition of the at least one PSBCH repetition is at or close to one edge of the S-SSB in the frequency domain, and another PSBCH repetition of the at least one PSBCH repetition is at or close to the other edge of the S-SSB in the frequency domain.

In some embodiments, a total number of the at least one RB and the location of each one of the at least one RB are identical for all symbols in the at least one S-SSB in the slot format.

In some embodiments, the first configuration includes a second structure configuration in the frequency domain of a symbol of the at least one symbol of each S-SSB, and the second structure configuration includes at least one of the followings: an interlace pattern in a frequency band, index(es) of available interlace(s) for a S-SSB in the frequency band, at least one interlace for one S-SSB, index(es) of available interlace(s) for a SLSS in the frequency band, at least one interlace for one SLSS, index(es) of available interlace(s) for a PSBCH in the frequency band, or at least one interlace for one PSBCH.

In some embodiments, the processor is further configured to: select the interlace(s) based on at least one of: random selection, an identifier of the UE, an identifier of a SLSS associated with the UE, or a priority level of synchronization reference of the UE.

In some embodiments, the processor is further configured to: obtain a second configuration associated with the slot format, wherein the second configuration includes at least one of the followings: at least one symbol as a gap for performing an LBT procedure, or location of each one of the at least one symbol.

In some embodiments, the processor is further configured to: obtain a third configuration associated with the slot format including at least one S-SSB multiplexed with SL data in at least one of a time domain or the frequency domain, wherein the third configuration includes at least one of the followings: location(s) of the SL data in the slot format in the time domain, or location(s) of the SL data in the slot format in the frequency domain.

In some embodiments, the processor is further configured to: obtain a fourth configuration associated with the slot format, wherein the fourth configuration includes at least one of the followings: a length of the S-SSB period, at least one S-SSB within the S-SSB period, an offset from a starting slot of the S-SSB period to a first slot containing S-SSB within the S-SSB period, or an interval between two adjacent slots containing S-SSB.

In some embodiments, the first configuration is configured based on at least one of the following granularities: per channel bandwidth, per carrier, per bandwidth part, per frequency range, or per subcarrier spacing (SCS).

In some embodiments, the first configuration is received via at least one of: a master information block (MIB) message, a system information block (SIB) message, a radio resource control (RRC) signalling, or a medium access control (MAC) control element (CE).

Another embodiment of the present disclosure provides a BS, comprising: a transceiver; and a processor coupled with the transceiver and configured to: transmit, with the transceiver, a first configuration for S-SSB in an unlicensed spectrum, wherein the first configuration for S-SSB is associated with a slot format including at least one S-SSB, and wherein at least one SLSS is multiplexed with at least one PSBCH in a frequency domain in at least one symbol of the at least one S-SSB.

In some embodiments, the first configuration includes a first structure configuration in the frequency domain of a symbol of the at least one symbol of each S-SSB, and the first structure configuration includes at least one of the followings: at least one PSBCH repetition, location of each one of the at least one PSBCH repetition, at least one SLSS repetition, location of each one of the at least one SLSS repetition, at least one RB unoccupied by the at least one PSBCH repetition and/or the at least one SLSS repetition, or location of each one of the at least one RB in the frequency band.

In some embodiments, one SLSS repetition of the at least one of SLSS repetition is at or close to an edge of the S-SSB in the frequency domain.

In some embodiments, one PSBCH repetition of the at least one PSBCH repetition is at or close to one edge of the S-SSB in the frequency domain, and another PSBCH repetition of the at least one PSBCH repetition is at or close to the other edge of the S-SSB in the frequency domain.

In some embodiments, a total number of the at least one RB and the location of each one of the at least one RB are identical for all symbols in the at least one S-SSB in the slot format.

In some embodiments, the first configuration includes a second structure configuration in the frequency domain of a symbol of the at least one symbol of each S-SSB, and the second structure configuration includes at least one of the followings: an interlace pattern in a frequency band, index(es) of available interlace(s) for a S-SSB in the frequency band, at least one interlace for one S-SSB, index(es) of available interlace(s) for a SLSS in the frequency band, at least one interlace for one SLSS, index(es) of available interlace(s) for a PSBCH in the frequency band, or at least one interlace for one PSBCH.

In some embodiments, the processor is further configured to: transmit, with the transceiver, a second configuration associated with the slot format, wherein the second configuration includes at least one of the followings: at least one symbol as a gap for performing an LBT procedure, or location of each one of the at least one symbol.

In some embodiments, the processor is further configured to: transmit, with the transceiver, a third configuration associated with the slot format including at least one S-SSB multiplexed with SL data in at least one of a time domain or the frequency domain, wherein the third configuration includes at least one of the followings: location(s) of the SL data in the slot format in the time domain, or location(s) of the SL data in the slot format in the frequency domain.

In some embodiments, the processor is further configured to: transmit, with the transceiver, a fourth configuration associated with the slot format, wherein the fourth configuration includes at least one of the followings: a length of the S-SSB period, at least one S-SSB within the S-SSB period, an offset from a starting slot of the S-SSB period to a first slot containing S-SSB within the S-SSB period, or an interval between two adjacent slots containing S-SSB.

In some embodiments, the first configuration is configured based on at least one of the following granularities: per channel bandwidth, per carrier, per bandwidth part, per frequency range, or per SCS.

In some embodiments, the first configuration is received via at least one of: a MIB message, a SIB message, a RRC signalling, or a MAC CE.

Yet another embodiment of the present disclosure provides a method performed by a UE, comprising: obtaining a first configuration for S-SSB in an unlicensed spectrum based on configuration or pre-configuration, wherein the first configuration for S-SSB is associated with a slot format including at least one S-SSB, and wherein at least one SLSS is multiplexed with at least one PSBCH in a frequency domain in at least one symbol of the at least one S-SSB; selecting at least one S-SSB occasion at least based on the first configuration; and transmitting an S-SSB on the at least one S-SSB occasion in response to a LBT procedure associated with the at least one S-SSB occasion being successful.

Still another embodiment of the present disclosure provides a method performed by a BS, comprising: transmitting a first configuration for S-SSB in an unlicensed spectrum, wherein the first configuration for S-SSB is associated with a slot format including at least one S-SSB, and wherein at least one SLSS is multiplexed with at least one PSBCH in a frequency domain in at least one symbol of the at least one S-SSB.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present disclosure.

FIG. 2 illustrates an S-SSB slot according to some embodiments of the present disclosure.

FIG. 3 illustrates distribution of occasions for S-SSB according to some embodiments of the present disclosure.

Each of FIG. 4A and FIG. 4B illustrates a structure for a slot containing S-SSB according to some embodiments of the present disclosure.

Each of FIGS. 5A and 5B illustrate a structure for a slot containing S-SSB according to some embodiments of the present disclosure.

FIG. 6 illustrates an interlaced structure for S-SSB in the frequency domain according to some embodiments of the present disclosure.

Each of FIG. 7A and FIG. 7B illustrates a structure for a slot containing S-SSB according to some embodiments of the present disclosure.

Each of FIGS. 8A-8D illustrates a structure for a slot containing at least one S-SSB multiplexed with SL data according to some embodiments of the present disclosure.

FIG. 9 illustrates a method for S-SSB transmission in an unlicensed spectrum according to some embodiments of the present disclosure.

FIG. 10 illustrates an apparatus for S-SSB transmission in an unlicensed spectrum according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3GPP 5G new radio (NR), 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates a wireless communication system 100 in accordance with some embodiments of the present disclosure.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present disclosure, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

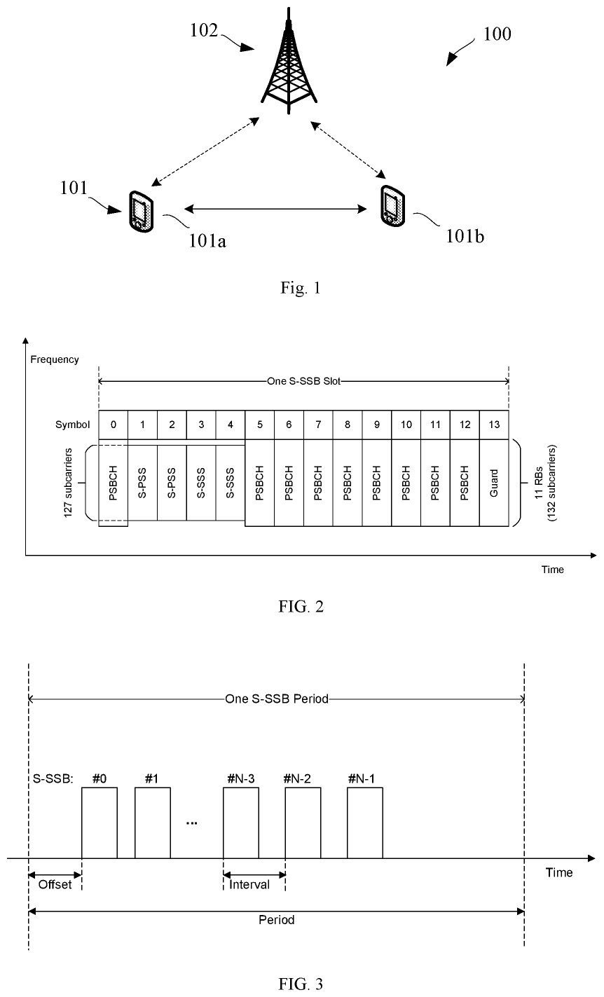

Sidelink synchronization information is carried in an S-SSB that consists of PSBCH, sidelink primary synchronization signal (S-PSS) and sidelink secondary synchronization signal (S-SSS). FIG. 2 illustrates an S-SSB slot according to some embodiments of the present disclosure. In the embodiments of FIG. 2, a normal cyclic prefix (CP) can be used.

Referring to FIG. 2, an example of S-SSB can occupy one slot in the time domain and occupy 11 RBs in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

One of the purposes of the arrangement of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC) purpose. The last symbol, e.g., symbol #13, in the S-SSB slot is used as a guard symbol.

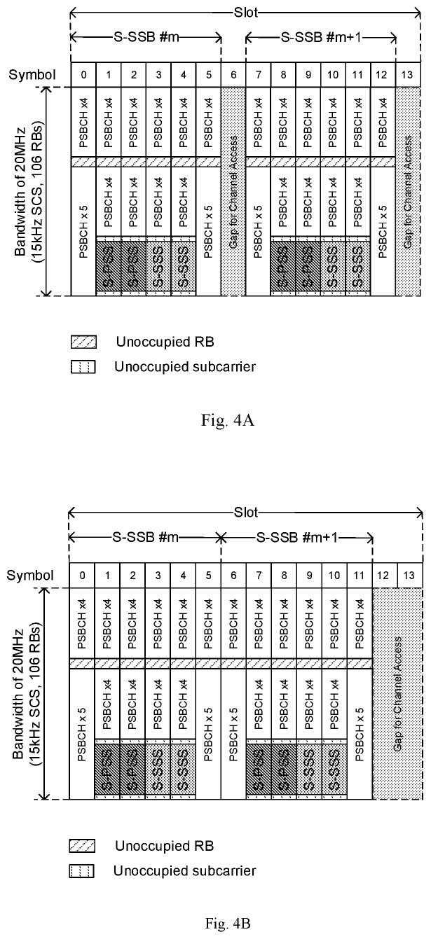

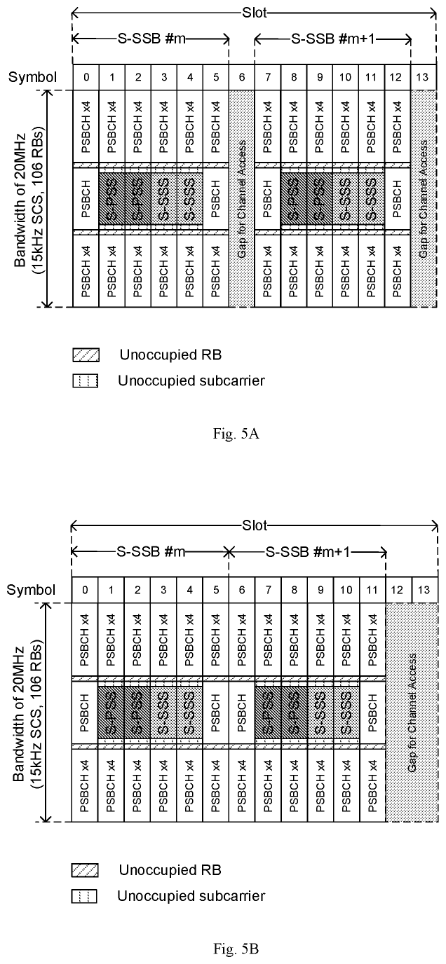

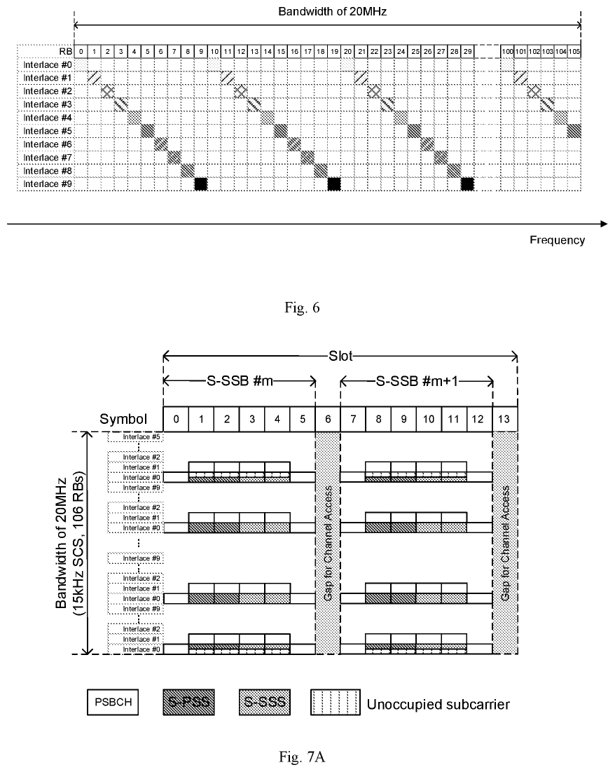

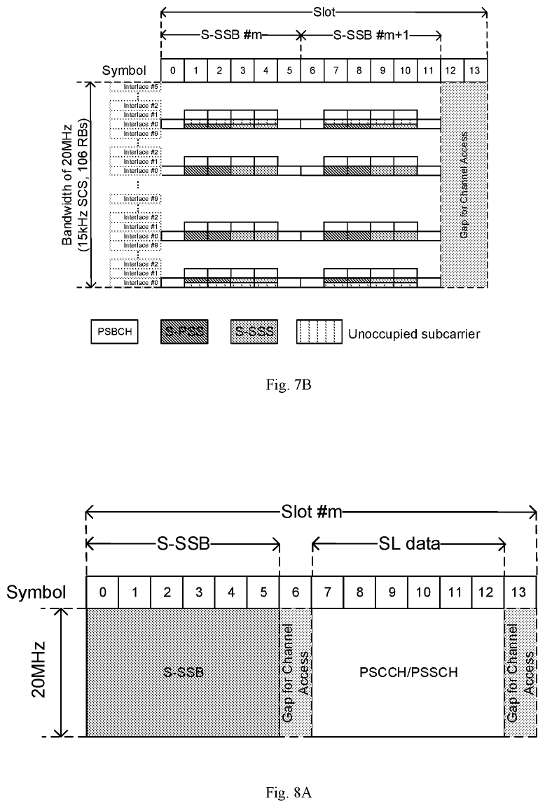

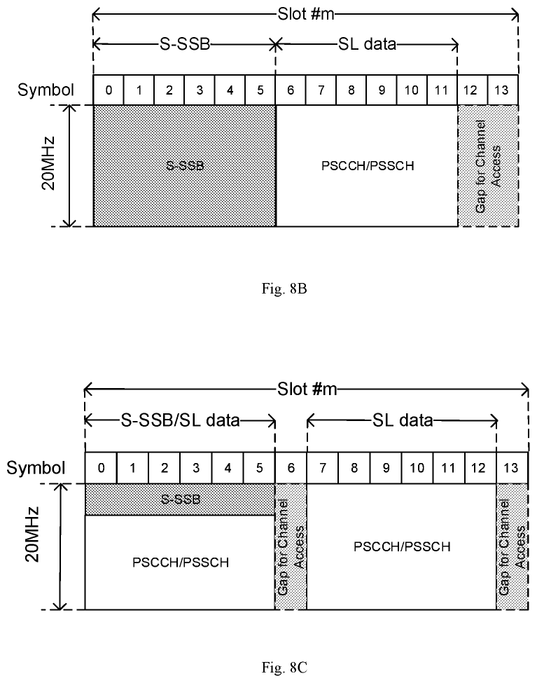

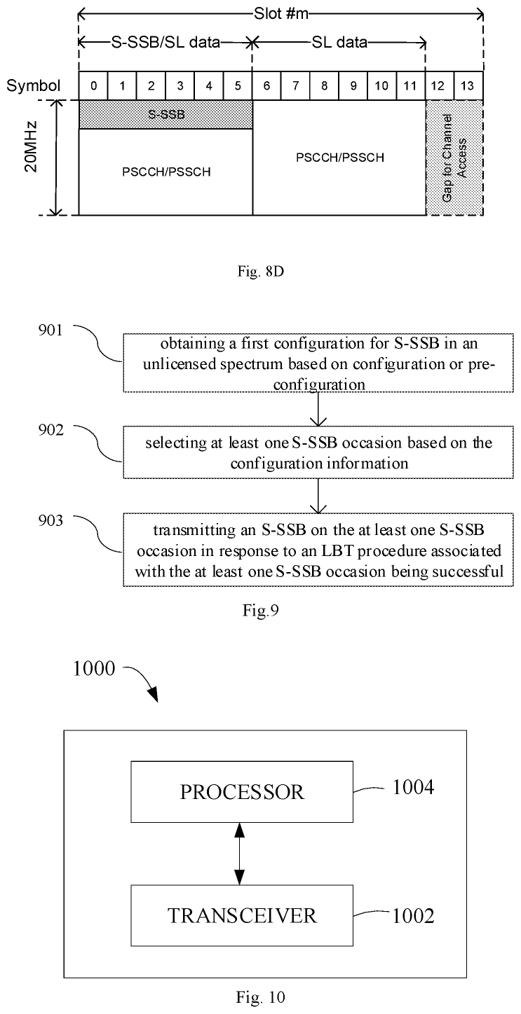

A UE may be configured with a configuration for an S-SSB period including one or more S-SSB occasions. FIG. 3 illustrates distribution of occasions for S-SSB according to some embodiments of the present disclosure.

As shown in FIG. 3, within one S-SSB period, there can be a number of “N” S-SSB occasions, which include S-SSB #0, S-SSB #1, . . . , S-SSB #N−3, S-SSB #N−2, and S-SSB #N−1, respectively. A length of the S-SSB period is denoted as “Period”. There is an offset from the starting slot of the S-SSB period to the first S-SSB occasion within the S-SSB period, e.g., S-SSB #0, which is marked as “Offset” in FIG. 3. There is an interval between two adjacent S-SSB occasions (e.g., between starting slots of the two adjacent S-SSB occasions). For example, as shown in FIG. 3, the interval between S-SSB #N−3 and S-SSB #N−2 is denoted as “Interval”. Accordingly, the configuration for one S-SSB period may include at least one of the parameter “Period”, the parameter “Offset”, or the parameter “Interval”. A UE may select one or more SSB occasions for transmitting SSB(s) based on the configuration.

The S-SSB period may include 16 frames, e.g., 160 ms, as specified in NR V2X. Possible numbers of S-SSB occasions within one S-SSB period are shown in the following Table 1:

TABLE 1
Number of S-SSB occasions within an S-SSB Period (160 ms)

| Frequency | Subcarrier spacing | Number of S-SSB occasions per |
|---|---|---|
| range | (SCS) | period |
| FR1 | 15 kHz | 1 |
| | 30 kHz | 1, 2 |
| | 60 kHz | 1, 2, 4 |
| FR2 | 60 kHz | 1, 2, 4, 8, 16, 32 |
| | 120 kHz | 1, 2, 4, 8, 16, 32, 64 |

For S-SSB transmission in an unlicensed spectrum, several issues need to be solved. The first issue is how to meet the OCB requirement for large channel bandwidth in the unlicensed spectrum. According to the OCB requirement, the bandwidth containing 99% of the power of the signal, shall be between 80% and 100% of declared nominal channel bandwidth. The second issue is how to meet the LBT requirement. A UE needs to perform an LBT procedure before the S-SSB transmission.

In addition to wider channel bandwidth caused by the unlicensed spectrum to be applied, some advanced application scenarios result in new issues, such as supporting latency-critical traffics, supporting beam-based transmission and so on. To solve the issues calls for providing more occasions for S-SSB and shorter duration for S-SSB in the time domain.

The present disclosure provides various solutions for S-SSB transmission in the unlicensed spectrum which can solve at least one of the above issues.

### Solution 1

In the present disclosure, an S-SSB may span

$${N}_{RB}^{S - SSB}$$

RBs in the frequency domain and may occupy

$${N}_{symbol}^{S - SSB}$$

symbols within a slot in the time domain, where

$${N}_{symbol}^{S - SSB}$$

is an integer with a range from 1 to 14. In at least one symbol of the

$${N}_{sysmbol}^{S - SSB}$$

symbols, SLSS is multiplexed with PSBCH in the frequency domain.

In order to meet the OCB requirement, the present disclosure proposes to deploy PSBCH(s) and/or SLSS(s) repeatedly in the frequency domain in each symbol of the S-SSB. The repeatedly deployed PSBCH(s) or SLSS(s) may be referred to as PSBCH repetition(s) or SLSS repetition(s) in the present disclosure, respectively. Wherein, each of PSBCH repetition or SLSS repetition occupies contiguous RBs in the frequency domain. The structure of the SSB may be referred to as a contiguous RB-based structure.

For example, it is assumed that a frequency band (e.g., a channel) includes a number of RBs in the frequency domain, which may be represented as

$${N}_{RB}^{CH} .$$

A PSBCH repetition or a SLSS repetition of an S-SSB may include N_{RB}^{Repetition} RBs, for example, 11 RBs, in the frequency domain. In at least one symbol of the

$${N}_{sysmbol}^{S - SSB}$$

symbols,

$${N}_{Repetition}^{SLSS}$$

SLSS repetition(s) is multiplexed with

$${N}_{Repetiiion}^{PSBCH}$$

PSBCH repetition(s) in the frequency domain. Wherein,

$${N}_{Repetition}^{SLSS}$$

is an integer with a range greater than or equal to one, and

$${N}_{Repetition}^{PSBCH}$$

is an integer with a range greater than or equal to one.

### Solution 1-1

For a slot including at least one S-SSB, in a symbol of the S-SSB without SLSS,

$$N {1}_{Repetition}^{PSBCH}$$

PSBCH repetition(s) may be transmitted in the frequency band. The maximum number of PSBCH repetition(s), denoted by

$$max N {1}_{Repetition}^{PSBCH} ,$$

may be calculated by the following equation (1):

$$max N {1}_{Repetition}^{PSBCH} = ⌊ \frac{{N}_{RB}^{CH}}{{N}_{RB}^{Repetition}} ⌋ \qquad ( 1 )$$

There may be some unoccupied RBs in the frequency band in the symbol without SLSS. The number of unoccupied RBs, denoted by

$$N {1}_{RB}^{unoccupied} ,$$

may be calculated by the following equation (2):

$$N {1}_{RB}^{unoccupied} = {N}_{RB}^{CH} - {N}_{RB}^{Repetition} \times N {1}_{Repetition}^{PSBCH} \qquad ( 2 )$$

The location(s) of the unoccupied RB(s) may be deployed based on the OCB requirements. For example, the unoccupied RB(s) may be deployed at any of the following locations: close to the centre frequency of the frequency band, close to or at the edge of the frequency band, between any two PSBCH repetitions, or other locations.

In the case that

$${N}_{RB}^{CH}$$

is divisible by

$${N}_{RB}^{Repetition} ,$$

there may be

$$max N {1}_{Repetition}^{PSBCH}$$

PSBCH repetitions without unoccupied RBs in the frequency band in the symbol.

In a symbol of the S-SSB containing

$${N}_{Repetition}^{SLSS}$$

SLSS repetition(s),

$$N {2}_{Repetition}^{PSBCH}$$

PSBCH repetition(s) may be multiplexed with the SLSS repetition(s) in the frequency band. The maximum number of PSBCH repetition(s), denoted by

$$max N {2}_{Repetition}^{PSBCH} ,$$

may be calculated by the following equation (3):

$$max N {2}_{Repetition}^{PSBCH} = max N {1}_{Repetition}^{PSBCH} - {N}_{Repetition}^{SLSS} = ⌊ \frac{{N}_{RB}^{CH}}{{N}_{RB}^{Repetition}} ⌋ - {N}_{REpetition}^{SLSS} \qquad ( 3 )$$

The

$${N}_{Repetition}^{SLSS}$$

SLSS repetition(s) may be located at one edge or close to one edge within the frequency range of the S-SSB. The PSBCH repetition(s) may be deployed on one side of the

$${N}_{Repetition}^{SLSS}$$

SLSS repetition(s) such that the S-SSB spans over the required channel bandwidth.

For example, in a symbol containing

$${N}_{Repetition}^{SLSS}$$

SLSS repetition(s), the SLSS repetition(s) may be mapped to

$${N}_{RB}^{Repetition} \times {N}_{Repetition}^{SLSS}$$

RBs starting from the lowest RB within the frequency range of the S-SSB in ascending order. Then the PSBCH repetition(s) may be repeatedly mapped to the remaining part of the frequency range of the S-SSB with a repetition number of

$$N {2}_{Repetition}^{PSBCH} .$$

For the PSBCH demodulation reference signal (DMRS), it may follow the design of PSBCH DMRS as specified in NR V2X. The only difference is that: DMRS are transmitted in every PSBCH repetition and on every fourth subcarrier (starting from the first subcarrier of each PSBCH repetition).

There may also be some unoccupied RBs in the symbol with SLSS repetition(s) in the frequency band. The number of unoccupied RBs, denoted by

$$N {2}_{RB}^{unoccupied} ,$$

may be calculated by the following equation (4):

$$N {2}_{RB}^{unoccupied} = {N}_{RB}^{CH} - {N}_{RB}^{Repetition} \times ( {N}_{Repetition}^{SLSS} + N {2}_{Repetition}^{PSBCH} ) \qquad ( 4 )$$

In the case that

$${N}_{RB}^{CH}$$

is divisible by

$${N}_{RB}^{Repetition} ,$$

there may be

$${N}_{Repetition}^{SLSS}$$

SLSS repetition(s) and

$$max N {2}_{Repetition}^{PSBCH}$$

PSBCH repetition(s) without any unoccupied RBs in the frequency band in the symbol.

In the time domain, each S-SSB may occupy

$${N}_{symbol}^{S - SSB}$$

symbols. The value of

$${N}_{symbol}^{S - SSB}$$

may be an integer ranging from 1 to 14, for example, 2 symbols, 4 symbols, 5 symbols, etc. In some embodiment, the value of

$${N}_{symbol}^{S - SSB}$$

may be 6, among the 6 symbols:
The first symbol may be for transmitting the PSBCH repetition(s) for AGC purpose.
The second symbol to the fifth symbol may be for transmitting both the SLSS repetition(s) and the PSBCH repetition(s). In other words, the SLSS and the PSBCH are multiplexed in the second symbol to the fifth symbol. In particular, the second symbol and the third symbol may be for transmitting S-PSS repetition(s) and PSBCH repetition(s), and the fourth symbol and the fifth symbol may be for transmitting S-SSS repetition(s) and PSBCH repetition(s).
The sixth symbol may be for transmitting the PSBCH repetition(s).
The locations for unoccupied RBs are same for the

$${N}_{symbol}^{S - SSB}$$

symbols of the S-SSB.

In solution 1, each S-SSB may occupy

$${N}_{symbol}^{S - SSB}$$

symbols, for example, 6 symbols as shown in FIGS. 4A and 4B. In some other embodiment, the value of

$${N}_{symbol}^{S - SSB}$$

may be other integers, such as 4, among the 4 symbols: the first symbol and the fourth symbol may be for transmitting the PSBCH repetition(s); the second symbol and the third symbol may be for transmitting both the SLSS repetition(s) and the PSBCH repetition(s). In particular, the second symbol may be for transmitting S-PSS repetition(s) and PSBCH repetition(s), and the third symbol may be for transmitting S-SSS repetition(s) and PSBCH repetition(s).

Within each slot, in order to perform the channel access procedure as regulated in unlicensed spectrum, a gap for channel access procedure with LBT in the time domain is needed for sidelink SSB. The present disclosure proposes two options below for deploying the gap for channel access procedure with LBT in the slot including the S-SSB. The gap may include a number of symbols, where the number, denoted by

$${N}_{symbol}^{gap} ,$$

may depend on the SCS.

### Option A

In some embodiments, the gap may occupy one symbol. For a shorter SCS (e.g., 15 kHz or 30 kHz), the number of symbols of the gap may include one symbol. Accordingly, option A may be suitable for a frequency band with a shorter SCS. Nevertheless, option A may also be applied to a frequency band with a longer SCS.

### Option B

In some embodiments, the gap may occupy two consecutive symbols within a slot. For a longer SCS (e.g., 60 kHz or 120 kHz), the number of symbols of the gap may include more than one symbol. Accordingly, option B may be suitable for a frequency band with a longer SCS. Nevertheless, option B may also be applied to a frequency band with a shorter SCS.

Each of FIG. 4A and FIG. 4B illustrates a structure for a slot containing S-SSB according to some embodiments of the present disclosure.

Referring to FIG. 4A and FIG. 4B, the bandwidth of a frequency band is 20 MHz, the SCS thereof is 15 kHz, and the number of RBs in the frequency band equals 106, i.e., N_{RB}^{CH}=106, which may be referred to as RB #0 to RB #105 (the indexes of the RBs are not shown in the drawings). One slot includes two S-SSBs, S-SSB #m and S-SSB #m+1, as illustrated in FIG. 4A and FIG. 4B. The slot includes 14 OFDM symbols, i.e. symbol #0 to symbol #13. Each S-SSB occupies 6 symbols.

In FIG. 4A, S-SSB #m occupies symbol #0 to symbol #5, and S-SSB #m+1 occupies symbol #7 to symbol #12. Symbol #6 and symbol #13 may be two gaps for channel access procedure. More specifically, the gap is used by a UE to perform the channel access procedure with LBT. For example, in the case that an LBT procedure performed in symbol #6 is successful, a COT including the slot may be initiated and the UE may transmit the S-SSB #m+1 in the slot.

In FIG. 4B, S-SSB #m occupies symbol #0 to symbol #5, and S-SSB #m+1 occupies symbol #6 to symbol #11. A gap for channel access procedure contains symbol #12 and symbol #13.

The structure of S-SSB #m and that of S-SSB #m+1 is identical. Taking S-SSB #m as an example, the structure configuration of each symbol of the S-SSB #m is as follows:
The first symbol, i.e. symbol #0, is for transmitting PSBCH for AGC purpose.
No SLSS repetitions is included in the first symbol. According to equation (1), the maximum number of PSBCH repetition(s)

$$max N {1}_{Repetition}^{PSBCH}$$

is calculated as follows:

$$max N {1}_{Repetition}^{PSBCH} = ⌊ \frac{{N}_{RB}^{CH}}{{N}_{RB}^{Repetition}} ⌋ = ⌊ \frac{106}{11} ⌋ = 9$$

In the example of FIG. 4A and FIG. 4B,

$$N {1}_{Repetition}^{PSBCH} = 9 .$$

The number of unoccupied RBs is calculated according to equation (2) as follows:

$$N {1}_{RB}^{unoccupied} = {N}_{RB}^{CH} - {N}_{RB}^{Repetition} \times N {1}_{Repetition}^{PSBCH} = 106 - 11 \times 9 = 7$$

The locations for unoccupied RBs are the same for the 6 symbols of the S-SSB, they are configured to be deployed close to the centre frequency of the frequency band. For symbol #0, the unoccupied RBs may occupy the RBs between the fifth PSBCH repetition and the sixth PSBCH repetition.
According to the above, in symbol #0 of FIGS. 4A and 4B, nine PSBCH repetitions of S-SSB #m are transmitted in the frequency band, where each PSBCH repetition includes 11 consecutive RBs, and seven unoccupied RBs are deployed close to the centre frequency of the frequency band, for example, between the fifth PSBCH repetition and the sixth PSBCH repetition. Therefore, in the 106 RBs (RB #0 to RB #105) of the frequency band in symbol #0, the PSBCH repetitions and the unoccupied RBs are as follows:
   the first PSBCH repetition is transmitted from RB #0 to RB #10,
   the second PSBCH repetition is transmitted from RB #11 to RB #21,
   the third PSBCH repetition is transmitted from RB #22 to RB #32,
   the fourth PSBCH repetition is transmitted from RB #33 to RB #43,
   the fifth PSBCH repetition is transmitted from RB #44 to RB #54,
   the unoccupied seven RBs are from RB #55 to RB #61,
   the sixth PSBCH repetition is transmitted from RB #62 to RB #72,
   the seventh PSBCH repetition is transmitted from RB #73 to RB #83,
   the eighth PSBCH repetition is transmitted from RB #84 to RB #94, and
   the ninth PSBCH repetition is transmitted from RB #95 to RB #105.
To simplify the drawings, the five PSBCH repetitions including the first PSBCH repetition to the fifth PSBCH repetition are represented as “PSBCH×5”, and the four PSBCH repetitions including the sixth PSBCH repetition to the ninth PSBCH repetition are represented as “PSBCH×4” in symbol #0 in FIG. 4A and FIG. 4B.
The second symbol to the fifth symbol, i.e., symbol #1 to symbol #4, may be for transmitting both the SLSS repetition(s) and the PSBCH repetition(s). In particular, the second symbol and the third symbol may be for transmitting the S-PSS repetition(s) and the PSBCH repetition(s), and the fourth symbol and the fifth symbol may be for transmitting the S-SSS repetition(s) and the PSBCH repetition(s).
One SLSS repetition is included in each symbol of the second symbol to the fifth symbol, i.e.,

$${N}_{Repetition}^{SLSS} = 1 .$$

According to equation (3), the maximum number of PSBCH repetition(s)

$$max N {2}_{Repetition}^{PSBCH}$$

is calculated as follows:

$$max N {2}_{Repetition}^{PSBCH} = max N {1}_{Repetition}^{PSBCH} - {N}_{Repetition}^{SLSS} = 9 - 1 = 8$$

In each symbol of symbol #1 to symbol #4,

$$N {2}_{Repetition}^{PSBCH} = 8 .$$

The number of unoccupied RBs is calculated according to equation (4) as follows:

$$\begin{matrix}N {2}_{RB}^{unoccupied} = {N}_{RB}^{CH} - {N}_{RB}^{Reptition} \times ( {N}_{Repetition}^{SLSS} + N {2}_{Repetition}^{PSBCH} ) \\ = 106 - 11 \times ( 1 + 8 ) = 7\end{matrix}$$

The locations for unoccupied RBs are the same for the 6 symbols of the S-SSB, they are configured to be deployed close to the centre frequency of the frequency band. For symbol #1, the unoccupied RBs occupy the same RBs as in symbol #0, which are between the fourth PSBCH repetition and the fifth PSBCH repetition.
Accordingly, as shown in FIGS. 4A and 4B, in the 106 RBs of the frequency band in symbol #1, the SLSS (i.e. S-PSS), the unoccupied RBs, and the PSBCH repetitions are as follows:
   the SLSS (i.e. S-PSS) is transmitted from RB #0 to RB #10,
   the first PSBCH repetition is transmitted from RB #11 to RB #21,
   the second PSBCH repetition is transmitted from RB #22 to RB #32,
   the third PSBCH repetition is transmitted from RB #33 to RB #43,
   the fourth PSBCH repetition, is transmitted from RB #44 to RB #54,
   the unoccupied seven RBs are from RB #55 to RB #61,
   the fifth PSBCH repetition is transmitted from RB #62 to RB #72,
   the sixth PSBCH repetition is transmitted from RB #73 to RB #83,
   the seventh PSBCH repetition is transmitted from RB #84 to RB #94, and
   the eighth PSBCH repetition is transmitted from RB #95 to RB #105.
To simplify the drawings, the four PSBCH repetitions (the first PSBCH repetition to the fourth PSBCH repetition, or the fifth PSBCH repetition to the eighth PSBCH repetition) are represented as “PSBCH×4” in symbol #1 in FIG. 4A and FIG. 4B. Furthermore, there are 11 RBs (132 subcarriers) allocated for the SLSS, and the SLSS occupies 127 subcarriers in the frequency domain, which are from the third subcarrier relative to the start of the bandwidth up to the 129th subcarrier. There are 2 unoccupied subcarriers including the first subcarrier and the second subcarrier, and 3 unoccupied subcarriers including the 130th subcarrier to the 132th subcarrier in symbol #1. The structure of symbol #2 is identical to that of symbol #1.
For symbol #3 and symbol #4, the SLSS (i.e. S-SSS) is transmitted from RB #0 to RB #10. The PSBCH repetitions and the unoccupied RBs are identical to those in symbol #1.
The sixth symbol, i.e. symbol #5, is for transmitting PSBCH, and no SLSS repetitions is included in symbol #5, thus the maximum number of PSBCH repetitions is identical to that in symbol #0, i.e. 9. The structure of symbol #5 is identical to that of symbol #1.

In FIG. 4A, the structures of symbol #7 to symbol #12 correspond to the structures of symbol #0 to symbol #5, respectively. In FIG. 4B, the structures of symbol #6 to symbol #11 correspond to the structures of symbol #0 to symbol #5, respectively.

In some other embodiments, for a symbol of the S-SSB without SLSS, such as symbol #0 or symbol #5, the value of

$$N {1}_{Repetition}^{PSBCH}$$

may be 2, that is there are two PSBCH repetitions, and the offset in frequency between the first RB (lowest in the frequency domain) of the first PSBCH repetition and the last RB (highest in the frequency domain) of the second PSBCH repetition satisfies OCB requirement of the channel. The rest RBs unoccupied by the two PSBCH repetitions are unoccupied RBs. For a symbol of the S-SSB with SLSS repetition(s), such as symbol #1 to symbol #4, the value of

$$N {2}_{Repetition}^{PSBCH}$$

may be 1, that is there is only one PSBCH, and the offset in frequency between the first RB (lowest in the frequency domain) of the SLSS and the last RB (highest in the frequency domain) of the PSBCH repetition satisfies OCB requirement of the channel. The rest RBs unoccupied by the SLSS and the PSBCH are unoccupied RBs.

### Solution 1-2

Solution 1-2 differs from solution 1-1 in the locations of the PSBCH repetition(s) relative to the SLSS repetition(s). In this solution, there are at least two PSBCH repetitions in a symbol of the S-SSB, and one PSBCH repetition of the at least two PSBCH repetitions is deployed at one edge or close to one edge of the S-SSB, the other PSBCH repetition of the at least two PSBCH repetitions is deployed at the other edge or close to the other edge of the S-SSB. The offset in frequency between the first RB (lowest in the frequency domain) of the one PSBCH repetition and the last RB (highest in the frequency domain) of the other PSBCH repetition satisfies OCB requirement of the channel. For example, within the frequency range of S-SSB in a symbol (regardless of whether it contains SLSS repetition or not), the one PSBCH repetition may be mapped starting at the lowest RB and with a bandwidth up to

$${N}_{RB}^{Reptition}$$

RBs, while the other PSBCH repetition may be mapped to the highest

$${N}_{RB}^{Reptition}$$

RBs in an ascending order of the RBs.

The other PSBCH repetitions, the SLSS repetition(s) and the unoccupied RBs (if any) may be deployed between the at least two PSBCH repetitions in the frequency domain in the symbol. For example, the SLSS repetition(s) may be deployed close to or at the centre of the frequency band, and the unoccupied RB(s) may be deployed on both sides of the SLSS repetition(s) in the frequency domain. Other deployment of the PSBCH repetitions(s), the SLSS repetition(s), and the unoccupied RBs (if any) in the symbol may also be supported in this solution. For example, the SLSS repetition(s) may be deployed between any two PSBCH repetitions (which are included in the other PSBCH repetitions) in the frequency domain, and the unoccupied RB(s) may be deployed on both sides of any PSBCH repetition (which is included in the other PSBCH repetitions) in the frequency domain.

Regarding the maximum value of

$$max N {1}_{Repetition}^{PSBCH} ,$$

the number of unoccupied RBs

$$N {1}_{RB}^{unoccupied} ,$$

the maximum value of

$$max N {2}_{Repetition}^{PSBCH} ,$$

the number of unoccupied RBs

$$N {2}_{RB}^{unoccupied} ,$$

and the time domain configuration regarding the structure of the S-SSB, and the gaps for channel access procedure are similar to that in solution 1-1, and the details are omitted here.

Each of FIGS. 5A and 5B illustrates a structure for a slot containing S-SSB according to some embodiments of the present disclosure.

FIG. 5A differs from FIG. 4A in the locations of the PSBCH repetition(s) relative to the SLSS repetition(s), and FIG. 5B also differs from FIG. 4B in the locations of the PSBCH repetition(s) relative to the SLSS repetition(s).

Taking S-SSB #m in FIGS. 5A and 5B as an example, the structure configuration of each symbol of the S-SSB #m structure is as follows:
The first symbol, i.e. symbol #0, is for transmitting PSBCH for AGC purpose.
No SLSS repetitions is included in the first symbol. According to equation (1), the maximum number of PSBCH repetition(s) is 9. The number of unoccupied RBs is 7.
The locations for unoccupied RBs are the same for the 6 symbols of the S-SSB, for symbol #0, the unoccupied RBs occupy the RBs on each side of the fifth PSBCH.
According to the above, in symbol #0 of FIGS. 5A and 5B, nine PSBCH repetitions of S-SSB #m are transmitted in the frequency band, where each PSBCH repetition includes 11 consecutive RBs, and seven unoccupied RBs are deployed on each side of the fifth PSBCH, for example, three RBs on one side and four on the other side. Therefore, in the 106 RBs (RB #0 to RB #105) of the frequency band in symbol #0, the PSBCH repetitions and the unoccupied RBs are as follows:
   the first PSBCH repetition is transmitted from RB #0 to RB #10,
   the second PSBCH repetition is transmitted from RB #11 to RB #21,
   the third PSBCH repetition is transmitted from RB #22 to RB #32,
   the fourth PSBCH repetition is transmitted from RB #33 to RB #43,
   the unoccupied three RBs are from RB #44 to RB #46,
   the fifth PSBCH repetition is transmitted from RB #47 to RB #57,
   the unoccupied four RBs are from RB #58 to RB #61,
   the sixth PSBCH repetition is transmitted from RB #62 to RB #72,
   the seventh PSBCH repetition is transmitted from RB #73 to RB #83,
   the eighth PSBCH repetition is transmitted from RB #84 to RB #94, and
   the ninth PSBCH repetition is transmitted from RB #95 to RB #105.
To simplify the drawings, the four PSBCH repetitions including the first PSBCH repetition to the fourth PSBCH repetition are represented as “PSBCH×4”, the fifth PSBCH repetition is represented as “PSBCH”, and the four PSBCH repetitions including the sixth PSBCH repetition to the ninth PSBCH repetition are also represented as “PSBCH×4” in symbol #0 in FIG. 5A and FIG. 5B.
The second symbol to the fifth symbol, i.e., symbol #1 to symbol #4, may be for transmitting both the SLSS repetition(s) and the PSBCH repetition(s). In particular, the second symbol and the third symbol may be for transmitting the S-PSS repetition(s) and the PSBCH repetition(s), and the fourth symbol and the fifth symbol may be for transmitting the S-SSS repetition(s) and the PSBCH repetition(s).
SLSS repetition(s) is included in the second symbol to the fifth symbol. In particular, one SLSS repetition is included in the second symbol to the fifth symbol. According to equation (3), the maximum number of PSBCH repetition(s)

$$max N {2}_{Repetition}^{PSBCH}$$

is 8. In the example of FIG. 5A and FIG. 5B,

$$N {2}_{Repetition}^{PSBCH} = 8 .$$

The number of unoccupied RBs is calculated according to equation (4) as 7.
The locations for unoccupied RBs are the same for the 6 symbols of the S-SSB, which are configured to be deployed close to the centre frequency of the frequency band. For symbol #1, the unoccupied RBs occupy the same RBs as in symbol #0, which are the RBs on each side of the SLSS repetition (i.e. S-PSS).
According to the above, in symbol #1 of FIGS. 5A and 5B, eight PSBCH repetitions of S-SSB #m are transmitted in the frequency band, where each PSBCH repetition includes 11 consecutive RBs, one SLSS repetition of S-SSB #m is transmitted in the frequency band, and the SLSS repetition includes 11 consecutive RBs, and seven unoccupied RBs are deployed on each side of the SLSS, for example, three RBs on one side and four on the other side. Therefore, in symbol #1, the 106 RBs in the frequency band, the PSBCH repetitions and the unoccupied RBs are as follows:
   the first PSBCH repetition is transmitted from RB #0 to RB #10,
   the second PSBCH repetition is transmitted from RB #11 to RB #21,
   the third PSBCH repetition is transmitted from RB #22 to RB #32,
   the fourth PSBCH repetition is transmitted from RB #33 to RB #43,
   the unoccupied three RBs are from RB #44 to RB #46,
   the SLSS (i.e. S-PSS) is transmitted from RB #47 to RB #57,
   the unoccupied four RBs are from RB #58 to RB #61,
   the fifth PSBCH repetition is transmitted from RB #62 to RB #72,
   the sixth PSBCH repetition is transmitted from RB #73 to RB #83,
   the seventh PSBCH repetition is transmitted from RB #84 to RB #94, and
   the eighth PSBCH repetition is transmitted from RB #95 to RB #105.
To simplify the drawings, the four PSBCH repetitions including the first PSBCH repetition to the fourth PSBCH repetition are represented as “PSBCH×4”, and the four PSBCH repetitions including the fifth PSBCH repetition to the eighth PSBCH repetition are also represented as “PSBCH×4” in symbol #0 in FIG. 5A and FIG. 5B. Furthermore, there are 2 unoccupied subcarriers including the first subcarrier and the second subcarrier in the RB set including RB #47 to RB #57, and 3 unoccupied subcarriers including the 130th subcarrier to the 132^{th} subcarrier in the RB set including RB #47 to RB #57. The structure of symbol #2 is identical to that of symbol #1.
For symbol #3 and symbol #4, the RBs of the SLSS repetition (i.e. S-SSS), is transmitted from RB #47 to RB #57 s. The PSBCH repetitions and the unoccupied RBs are identical to those in symbol #1.
The sixth symbol, i.e. symbol #5, is for transmitting PSBCH, and no SLSS repetitions is included in symbol #5, thus the maximum number of PSBCH repetitions is identical to that in symbol #0, i.e. 9. The structure of symbol #5 is identical to that of symbol #0.

In FIG. 5A, the structures of symbol #7 to symbol #12 correspond to the structures of symbol #0 to symbol #5 respectively. In FIG. 5B, the structures of symbol #6 to symbol #11 correspond to the structures of symbol #0 to symbol #5 respectively.

In some other embodiments, for each symbol in symbol #0 to symbol #5, there may be two PSBCH repetitions, and the offset in frequency between the first RB (lowest in the frequency domain) of the first PSBCH repetition and the last RB (highest in the frequency domain) of the second PSBCH repetition satisfies OCB requirement of the channel. The other RBs unoccupied by the SLSS repetition(s) and/or the PSBCH repetitions are unoccupied RBs.

The configuration information of the S-SSB structure may be configured to the UE by the BS (or the network) or pre-configured to the UE. In 3GPP, a UE under network coverage will be configured with a set of parameters needed for proper sidelink communication, which is referred to as configuration or configuration information. In the case of pre-configuration, the parameters, especially needed for sidelink communication outside network courage, can be hard-wired into the UE or stored on a subscriber identity module (SIM) card for the UE. The S-SSB structure may include at least one of the following:
S-SSB structure in a slot contains the structure configuration in the frequency domain per symbol within an S-SSB, which may include at least one of the following:
   1. at least one PSBCH repetition,
   2. location of each one of the at least one PSBCH repetition,
   3. at least one of SLSS repetition,
   4. location of each one of the at least one SLSS repetition,
   5. at least one RB unoccupied by PSBCH repetition and/or SLSS repetition,
   6. location of each one of the at least one unoccupied RB in the frequency band.

In accordance with the example in FIG. 4A, for symbol #1, the configuration information may indicate that there are eight PSBCH repetitions, the locations of the eight PSBCH repetitions, there is one SLSS (i.e. S-PSS) repetition, the location of the one SLSS repetition, there are seven unoccupied RBs, and the location of the seven unoccupied RBs.

The granularity of the configuration information of the S-SSB structure may be:
per channel bandwidth: the configuration information may be different for different channel bandwidths, such as 20 MHz, 25 MHz, 40 MHz, etc.;
per carrier: the configuration information may be different for different carriers;
per bandwidth part: the configuration information may be different for different bandwidth parts;
per frequency range: the configuration information may be different for different frequency ranges, such as frequency range 1 (FR1), FR2, etc., or
per SCS: the configuration information may be different for different SCSs, such as 15 kHz, 30 kHz, etc.

The configuration information of the S-SSB structure may be transmitted from the BS to the UE via a MIB message, a SIB message, an RRC signalling, a MAC CE, or the like.

The configuration information of the gap may be configured to the UE by the BS (or the network) or pre-configured to the UE. The slot may include the number of the symbol(s) as the gap for channel access procedure (i.e., the gap for performing an LBT procedure), or the location(s) of the symbol(s) as the gap for channel access procedure. For the example in FIG. 4A, the configuration information of the gap may indicate that the number of the symbol(s) as the gap for channel access procedure is one, and the location of the symbol as the gap for channel access procedure is symbol #13; or the configuration information of the gap may merely indicate the location of the symbol as the gap for channel access procedure is symbol #13, which implies that the number of the symbol(s) as the gap for channel access procedure is one.

The granularity and the transmission manner of the configuration information of the gap are similar to those of the configuration information of the S-SSB structure in solution 1, and the details are omitted here.

In some other embodiments, the frequency band including

$${N}_{RB}^{CH}$$

RBs in the frequency domain is divided into a number of interlaces. The number of the interlaces is denoted as

$${N}_{Interlace}^{CH}$$

for simplicity, and every

$${{N}_{Interlace}^{CH}}^{th}$$

RBs belongs to the same interlace.

An interlace may include an RB set. The maximum number of RBs in an interlace, denoted by

$$max {N}_{RB}^{Interlace} ,$$

may be calculated by the following equation (5):

$$max {N}_{RB}^{Interlace} = ⌈ \frac{{N}_{RB}^{CH}}{{N}_{Interlace}^{CH}} ⌉ \qquad ( 5 )$$

In the case that

$${N}_{RB}^{CH}$$

is divisible by

$${N}_{Interlace}^{CH} ,$$

the total number of RBs included in each interlace of the

$${N}_{Interlace}^{CH}$$

interlaces is

$$max {N}_{RB}^{Interlace} .$$

In the case that

$${N}_{RB}^{CH}$$

is not divisible by

$${N}_{Interlace}^{CH} ,$$

some interlaces include

$$max {N}_{RB}^{Interlace}$$

RBs, while others include

$$max {N}_{RB}^{Interlace} - 1$$

### RBs.

If the first interlace, interlace #0, includes

$$max {N}_{RB}^{Interlace}$$

RBs, it may include the 1^{st} RB, the

$${( 1 + {N}_{Interlace}^{CH} )}^{th}$$

### RB, the

$${( 1 + 2 \times {N}_{Interlace}^{CH} )}^{th}$$

### RB, . . . , and the

$${( 1 + ( max {N}_{RB}^{Interlace} - 1 ) \times {N}_{Interlace}^{CH} )}^{t h}$$

RB. If the m1^{th} interlace, interlace #m1-1, includes

$$max {N}_{RB}^{Interlace} - 1$$

RBs, it may include the m1^{th} RB, the

$${( m 1 + {N}_{Interlace}^{CH} )}^{t h}$$

### RB, . . . , the

$${( m 1 + ( max {N}_{RB}^{Interlace} - 2 ) \times {N}_{Interlace}^{CH} )}^{th}$$

### RB.

Among the

$${N}_{Interlace}^{CH}$$

interlaces, there may be some interlaces that include a number of RBs which is no less than the number of RBs of a PSBCH repetition or an SLSS repetition of an S-SSB, i.e.,

$${N}_{RB}^{Repetition} .$$

These interlaces are considered as available interlaces, and a PSBCH repetition or an SLSS repetition may be mapped to a set (or subset) of RBs of an available interlace by one-to-one mapping. Some interlaces may include a number of RBs which is less than

$${N}_{RB}^{Repetition} ,$$

and these interlaces are considered as unavailable interlaces, in which the number of RBs is insufficient in supporting one-to-one mapping for a PSBCH repetition or an SLSS repetition of an S-SSB. In some other embodiments, the interlaces that include a number of RBs less than

$${N}_{RB}^{Repetition}$$

may also be considered as available interlaces for an S-SSB. For example, in the case that interlace #m2 includes

$${N}_{RB}^{Interlace \# m 2}$$

RBs, where

$${N}_{RB}^{Interlace \# m 2}$$

is less than

$${N}_{RB}^{Repetition} ,$$

the next available interlace, such as interlace #(m2+1), may be used jointly with the interlace #m2 to provide sufficient RBs in supporting one-to-one mapping for a PSBCH repetition or an SLSS repetition of an S-SSB. In that case, the S-SSB can be mapped to the RB set of interlace #m2 and a part of the RB set of interlace #(m2+1), and interlace #m2 is also considered as an available interlace. In some other embodiments, some RBs of a PSBCH repetition or an SLSS repetition of an S-SSB may be punctured, and the PSBCH repetition or the SLSS repetition with a reduced number of RBs may be mapped to the interlace with a number of RBs less than

$${N}_{RB}^{Repetition} .$$

FIG. 6 illustrates an interlaced structure for S-SSB in the frequency domain according to some embodiments of the present disclosure.

FIG. 6 illustrates a frequency band with a bandwidth of 20 MHz and an SCS of 15 kHz, and the number of RBs in the frequency band equals to 106, which includes RB #0, RB #1, . . . , RB #105. There are

$${N}_{Interlace}^{CH} = 10$$

interlaces, e.g., interlace #0, interlace #1, . . . , interlace #9, included in the frequency band. Based on the above equation (5), the maximum number of RBs in an interlace of the 10 interlaces is calculated as follows:

$$max {N}_{RB}^{Interlace} = ⌈ \frac{{N}_{RB}^{CH}}{{N}_{Interlace}^{CH}} ⌉ = ⌈ \frac{106}{10} ⌉ = 11$$

From interlace #0 to interlace #5, each interlace contains 11 RBs. For example, interlace #0 includes 11 RBs, which are RB #0, RB #10, RB #20, . . . , and RB #100; interlace #5 includes 11 RBs, which are RB #5, RB #15, RB #25, . . . , and RB #105. From interlace #6 to interlace #9, each interlace contains

$$( max {N}_{RB}^{Interlace} - 1 )$$

RBs, i.e., 10 RBs. For example, interlace #6 includes 10 RBs, which are RB #6, RB #16, RB #26, and RB #96; interlace #9 includes 10 RBs, which are RB #9, RB #19, RB #29, . . . , and RB #99.

Each of a PSBCH repetition or an SLSS repetition of an S-SSB includes

$${N}_{RB}^{Repetition}$$

(e.g. 11) RBs in the frequency domain. Since the number of RBs included in one PSBCH repetition or one SLSS repetition is 11, and each interlace of interlace #0 to interlace #5 includes 11 RBs, the RBs of one PSBCH repetition or one SLSS repetition may be mapped to one interlace of interlace #0 to interlace #5 by one-to-one mapping. Therefore, interlace #0 to interlace #5 are considered as available interlaces for S-SSB. Each interlace of interlace #6 to interlace #9 includes 10 RBs, and they are not considered as available interlaces.

The UE may select one or more interlaces from available interlace #0 to interlace #5, and map the RBs of the S-SSB to the RB sets of the selected interlaces.

### Solution 2

In solution 2,

$${N}_{Repetition}^{SLSS , I}$$

SLSS repetition(s) of an S-SSB is multiplexed with

$${N}_{Repetition}^{P SBCH , I}$$

PSBCH repetition(s) of the S-SSB in an interlaced structure such that the S-SSB span over the required channel bandwidth, where

$${N}_{Repetition}^{SLSS , I}$$

is an integer with a range from 0 to the maximum number of available interlaces, and

$${N}_{Repetition}^{P SBCH , I}$$

is an integer from 1 to the maximum number of available interlaces, and the maximum number of available interlaces is determined based on the configuration of the frequency band. The structure of the SSB may be referred to as an interlace RB-based structure.

The

$${N}_{Repetition}^{SLSS , I}$$

SLSS repetition(s) and the

$${N}_{Repetition}^{PSBCH , I}$$

PSBCH repetition(s) may be allocated to the available interlace(s) in the frequency domain.

Within one S-SSB, in a symbol with no SLSS, the

$${N}_{Repetition}^{PSBCH , I}$$

PSBCH repetition(s) may occupy

$${N}_{Interlace}^{PSBCH}$$

available interlace(s). In some embodiments, the set of

$${N}_{Interlace}^{PSBCH}$$

available interlace(s) for PSBCH repetition(s) may be configured to the UE by the BS (or the network) or pre-configured to the UE. In other embodiments, the set of

$${N}_{Interlace}^{PSBCH}$$

available interlace(s) for PSBCH repetition(s) may be selected by the UE with a constraint on the number of interlaces(s) used for PSBCH configured for the symbol. For example, the

$${N}_{Repetition}^{PSBCH , I}$$

repetition(s) may occupy the first

$${N}_{Interlace}^{PSBCH}$$

available interlace(s) among all the available interlaces for S-SSB in the frequency band.

In a symbol with

$${N}_{Repetition}^{SLSS , I}$$

SLSS repetition(s), the

$${N}_{Repetition}^{SLSS , I}$$

SLSS repetition(s) may occupy

$${N}_{Interlace}^{SLSS}$$

available interlace(s), and the

$${N}_{Repetition}^{PSBCH , I}$$

PSBCH repetition(s) may occupy

$${N}_{Interlace}^{PSBCH}$$

available interlace(s) in the remaining interlace(s) available for the S-SSB. In some other embodiments, the

$${N}_{Repetition}^{PSBCH , I}$$

PSBCH repetition(s) may occupy in the first

$${N}_{Interlace}^{PSBCH}$$

available interlace(s) among all the available interlaces for the S-SSB in the frequency band, and the

$${N}_{Repetition}^{SLSS , I}$$

SLSS repetition(s) may occupy

$${N}_{Interlace}^{SLSS}$$

available interlace(s) in the remaining interlace(s) available for S-SSB.

Similarly, in some embodiments, the set of

$${N}_{Interlace}^{SLSS}$$

available interlace(s) for SLSS repetition(s) and the set of

$${N}_{Interlace}^{PSBCH}$$

available interlace(s) for PSBCH repetition(s) may be configured to the UE by the BS (or the network) or pre-configured to the UE. In other embodiments, the set of

$${N}_{Interlace}^{SLSS}$$

available interlace(s) for SLSS repetition(s) and the set of

$${N}_{Interlace}^{PSBCH}$$

available interlace(s) for PSBCH repetition(s) may be selected by the UE with a constraint on the number of interlaces(s) used for SLSS repetition(s) or PSBCH repetition(s) configured for the symbol. For example, the

$${N}_{Repetition}^{SLSS , I}$$

SLSS repetition(s) may occupy the first

$${N}_{Interlace}^{SLSS}$$

available interlace(s) among all the available interlaces for S-SSB in the frequency band. The

$${N}_{Repetition}^{PSBCH , I}$$

PSBCH repetition(s) may occupy the first

$${N}_{Interlace}^{PSBCH}$$

available interlace(s) among the remaining available interlaces for S-SSB in the frequency band.

In some embodiments, the UE may first select one or more interlaces from the available interlaces for transmitting an SLSS repetition(s) with the following options: the UE may select the one or more interlaces based on random selection. In some other embodiments, the UE may select a number of interlaces from the available interlaces based on the identifier of the UE. For example, the UE may select an interlace with an index obtained by the ID of the UE modulo the number of available interlaces. In still some other embodiments, the UE may select a number of interlaces from the available interlaces based on an SLSS identifier associated with the UE. For example, the UE may select an interlace with an index obtained by the SLSS ID associated with the UE modulo the number of available interlaces. In still some other embodiments, the UE may select a number of interlaces from the available interlaces based on a priority level of synchronization reference of the UE. For example, according to the 3GPP specification, five priority levels of synchronization reference are defined, i.e., level 1 to level 5, and the UE may select the first interlace if its priority level of synchronization reference is level 1, select the second interlace if its priority level of synchronization reference is level 2, etc.

After selecting the one or more available interlaces, the UE may map the SLSS repetition(s) to the RB sets of the selected interlaces. The UE may start with the interlace with the minimal index and map in ascending order of RB index until up to the maximum RB index in the interlace, and then perform the same operations to other interlaces in ascending order of interlace index until up to all the selected interlaces.

The UE may select one or more interlaces from the remaining available interlaces for transmitting an PSBCH repetition(s) in a similar fashion. Alternatively, the UE may select the interlaces for transmitting an PSBCH repetition(s) first, then the SLSS repetition(s).

The gap for performing the channel access procedure with LBT in the slot is similar to those in solution 1, and the details are omitted here.

Each of FIG. 7A and FIG. 7B illustrates a structure for a slot containing S-SSB according to some embodiments of the present disclosure.

FIG. 7A and FIG. 7B illustrate a frequency band identical to that of FIG. 6, and interlace #0 to interlace #5 are considered as available interlaces. One slot including two S-SSBs, e.g., S-SSB #m and S-SSB #m+1, is illustrated in FIG. 7A and FIG. 7B. The slot includes 14 OFDM symbols, i.e. symbol #0 to symbol #13. Each S-SSB occupies 6 symbols.

In FIG. 7A, S-SSB #m may occupy symbol #0 to symbol #5, and S-SSB #m+1 may occupy symbol #7 to symbol #12. Symbol #6 and symbol #13 may be two gaps for channel access procedure. More specifically, the gap is used by a UE to perform the channel access procedure with LBT. For example, in the case that an LBT procedure performed in symbol #6 is successful, a COT including the slot may be initiated and the UE may transmit the S-SSB #m+1 in the slot.

In FIG. 7B, S-SSB #m may occupy symbol #0 to symbol #5, and S-SSB #m+1 may occupy symbol #6 to symbol #11, and symbol #12 and symbol #13 may be a gap for channel access procedure. For example, in the case that an LBT procedure performed in symbol #12 and symbol #13 is successful, a COT including the next slot may be initiated and the UE may transmit the S-SSB in the next slot.

The

$${N}_{Repetition}^{PSBCH , I}$$

PSBCH repetition(s) may occupy

$${N}_{Interlace}^{PSBCH}$$

available interlace(s). For example, the

$${N}_{Repetition}^{PSBCH , I}$$

PSBCH repetition(s) may occupy the first

$${N}_{Interlace}^{PSBCH}$$

available interlace(s) among all the available interlaces for S-SSB in the frequency band.

For each symbol in symbol #0 and symbol #5, no SLSS is included, and the PSBCH occupies at least one available interlace, for example, the PSBCH occupies interlace #0.

For each symbol from symbol #1 to symbol #4, one SLSS is multiplexed with one PSBCH in an interlaced structure. The SLSS occupies at least one available interlace, for example, the SLSS occupies interlace #0, and the PSBCH occupies at least one available interlace in the remaining available interlaces for S-SSB in the frequency band, which includes interlace #1 to interlace #5, and the PSBCH may occupy interlace #1.

In FIG. 7A, the structures of symbol #7 to symbol #12 correspond to the structures of symbol #0 to symbol #5 respectively. In FIG. 7B, the structures of symbol #6 to symbol #11 correspond to the structures of symbol #0 to symbol #5 respectively.

In solution 2, each S-SSB may occupy

$${N}_{symbol}^{S - SSB}$$

symbols, for example, 6 symbols as shown in FIGS. 7A and 7B, in some other embodiments, the value

$${N}_{symbol}^{S - SSB}$$

of may be other integers, such as 4, among the 4 symbols: the first symbol and the fourth symbol may be for transmitting the PSBCH repetition(s); the second symbol and the third symbol may be for transmitting both the SLSS repetition(s) and the PSBCH repetition(s). In particular, the second symbol may be for transmitting S-PSS repetition(s) and PSBCH repetition(s), and the third symbol may be for transmitting S-SSS repetition(s) and PSBCH repetition(s).

The configuration information of the S-SSB structure may be configured to the UE by the BS (or the network) or pre-configured to the UE. The S-SSB structure may include at least one of the following:
S-SSB structure in a slot contains the structure configuration in the frequency domain per symbol within an S-SSB, which may include at least one of the following:
   1. an interlace pattern in a frequency band, for example, the number of interlaces and RB sets for each interlace,
   2. index(es) of available interlace(s) for a S-SSB in the frequency band, for example, interlace #0 to interlace #5,
   3. at least one interlace for one S-SSB, for example, one interlace for one S-SSB,
   4. index(es) of available interlace(s) for a SLSS in the frequency band, for example, interlace #0 to interlace #3 are for SLSS,
   5. at least one number of interlace for one SLSS, for example, one interlace for one SLSS,
   6. index(es) of available interlace(s) for a PSBCH in the frequency band, for example, interlace #4 and interlace #5 are for PSBCH, or
   7. at least one interlace for one PSBCH, for example, one interlace for one PSBCH.

The granularity and the transmission manner of the configuration information are similar to those of the configuration information of the S-SSB structure in solution 1, and the details are omitted here.

### Solution 3

In this solution, an S-SSB may be multiplexed with SL data in at least one of the frequency domain or the time domain, in which the S-SSB may include a structure as described in solution 1 (contiguous RB-based structure) or in solution 2 (interlace RB-based structure). The SL data may include PSCCH and/or PSSCH.

### Solution 3-1

Within one slot, the S-SSB may be multiplexed with SL data in the time domain. For example, the S-SSB may occupy some symbols in one slot, and the SL data may occupy some other symbols in the same slot.

In the frequency domain, in order to meet the OCB requirement, the SL data may also use the structure similar to the S-SSB, that is, the SL data may use the contiguous RB-based structure as solution 1 or the interlace RB-based structure in solution 2.

When the S-SSB and the SL data are multiplexed in the time domain, the S-SSB and the SL data may both adopt the same structure or adopt different structures.

### Solution 3-2

Within one slot, the S-SSB may be multiplexed with SL data in both the time domain and the frequency domain. For example, the S-SSB may be multiplexed with SL data in the frequency domain in some symbols in one slot, and some other symbols in the slot are for transmitting SL data. For another example, the S-SSB may be multiplexed with SL data in the frequency domain in some symbols in one slot, and some other symbols in the slot are for transmitting the S-SSB.

Each of FIGS. 8A-8D illustrate a structure for a slot containing at least one S-SSB multiplexed with SL data according to some embodiments of the present disclosure. A slot, slot #m, in a frequency band with a bandwidth of 20 MHz is shown.

In FIGS. 8A and 8B, the S-SSB and the SL data are multiplexed in the time domain.

In FIG. 8A, the S-SSB may occupy symbol #0 to symbol #5, and the SL data may occupy symbol #7 to symbol #12. Symbol #6 and symbol #13 may be two gaps for the channel access procedure with LBT. In FIG. 8B, the S-SSB may occupy symbol #0 to symbol #5, and the SL data may occupy symbol #6 to symbol #11. Symbol #12 and symbol #13 may be a gap for the channel access procedure with LBT.

In FIGS. 8C and 8D, the S-SSB and the SL data are multiplexed in both the time domain and the frequency domain.

In FIG. 8C, the S-SSB may occupy symbol #0 to symbol #5 in the time domain and may occupy a portion of the bandwidth in the frequency domain. The SL data may also occupy symbol #0 to symbol #5 in the time domain and may occupy the other portion of the bandwidth in the frequency domain. That is, in symbol #0 to symbol #5, the S-SSB and the SL data are multiplexed in the frequency domain. The SL data may also occupy symbol #7 to symbol #12. Symbol #6 and symbol #13 may be two gaps for the channel access procedure with LBT.

In FIG. 8D, the S-SSB may occupy symbol #0 to symbol #5 in the time domain and may occupy a portion of the bandwidth in the frequency domain. The SL data may also occupy symbol #0 to symbol #5 in the time domain and may occupy the other portion of the bandwidth in the frequency domain. That is, in symbol #0 to symbol #5, the S-SSB and the SL data are multiplexed in the frequency domain. The SL data may also occupy symbol #6 to symbol #11. Symbol #12 and symbol #13 may be a gap for the channel access procedure with LBT.

In solution 3, each S-SSB may occupy

$${N}_{symbol}^{S - SSB}$$

symbols, for example, 6 symbols as shown in FIGS. 8A-8D, in some other embodiments, the value

$${N}_{symbol}^{S - SSB}$$

may be other integers, such as 4. Among the 4 symbols: the first symbol and the fourth symbol may be for transmitting the PSBCH repetition(s); the second symbol and the third symbol may be for transmitting both the SLSS repetition(s) and the PSBCH repetition(s). In particular, the second symbol may be for transmitting S-PSS repetition(s) and PSBCH repetition(s), and the third symbol may be for transmitting S-SSS repetition(s) and PSBCH repetition(s).

Configuration associated with the slot structure including at least one S-SSB multiplexed with SL data in at least one of the time domain or the frequency domain may be (pre-) configured to the UE, in addition to the configuration related to the S-SSB structure (configuration of contiguous RB-based structure of the S-SSB or interlace RB-based structure of the S-SSB). In particular, the configuration contains the structure configuration in the frequency domain for SL data per symbol within the slot. The configuration may further include at least one of the followings:
location(s) of the SL data in the time domain in the slot format, i.e., the index(es) of symbol(s) containing SL data transmission, for example, from symbol #7 to symbol #12 in FIG. 8A, or from symbol #0 to symbol #5 and from symbol #7 to symbol #12 in FIG. 8C,
location(s) of the SL data in the frequency domain in the slot format, i.e., the set of RB(s) in the frequency band for SL data within each symbol containing SL data transmission, for example, all the frequency bandwidth of the frequency domain in FIG. 8A, or partial frequency bandwidth from symbol #0 to symbol #5 and all frequency bandwidth from symbol #7 to symbol #12 in FIG. 8C.

The granularity and the transmission manner of the configuration are similar to those of the configuration information of the S-SSB structure in solution 1, and the details are omitted here.

In some embodiments, the BS may transmit a configuration associated with an S-SSB period including the S-SSB occasions to the UE. The S-SSB occasions within the resource may be dedicated for S-SSB, or the S-SSB occasions within the resource pool may support multiplexing of S-SSB and SL data.

Specifically, the configuration may include at least one of the following:
a length of the S-SSB period,
a number of slot(s) containing S-SSB within the S-SSB period,
an offset from a starting slot of the S-SSB period to a first slot containing S-SSB within the S-SSB period, which is used for performing a channel access procedure with LBT. In order to have sufficient time for performing the LBT procedure, the offset is configured to be sufficient for performing a supported LBT type prior to an S-SSB window, or
an interval between two adjacent slots containing S-SSB, which is used for performing a channel access procedure with LBT. The interval is determined based on LBT type. Specifically, the interval is sufficient for performing a supported LBT type prior to an S-SSB window.
Information for channel access procedure, which may include the LBT type.

The granularity and the transmission manners of the configuration associated with an S-SSB period are similar to those of the configuration information of the S-SSB structure in solution 1, and the details are omitted here.

FIG. 9 illustrates a method for S-SSB transmission in an unlicensed spectrum according to some embodiments of the present disclosure.

Although the method is described with respect to a UE below, it is contemplated that the method may be performed by any other device with similar functions.

In operation 901, the UE may obtain a first configuration information for S-SSB in an unlicensed spectrum based on configuration or pre-configuration, wherein the first configuration for S-SSB is associated with a slot format including at least one S-SSB, and wherein at least one SLSS is multiplexed with at least one PSBCH in a frequency domain in at least one symbol of the at least one S-SSB. In operation 902, the UE may select at least one S-SSB occasion based on the first configuration. In operation 903, the UE may transmit an S-SSB on the at least one S-SSB occasion in response to a LBT procedure associated with the at least one S-SSB occasion being successful. The first configuration may be based on the configuration received from the BS or the network. Alternatively, the first configuration may be based on the pre-configuration, which is hard-wired into the UE or stored on a SIM card for the UE.

Correspondingly, at BS side, the BS may transmit the first configuration for S-SSB in an unlicensed spectrum to the UE.

In some embodiments, the first configuration includes a first structure configuration in the frequency domain of a symbol of the at least one symbol of each S-SSB, and the first structure configuration includes at least one of the followings: at least one PSBCH repetition, location of each one of the at least one PSBCH repetition, at least one SLSS, location of each one of the at least one SLSS, at least one RB unoccupied by the at least one PSBCH repetition and/or the at least one SLSS, or location of each one of the at least one RB in the frequency band. For example, as shown in FIG. 4A, for symbol #1, the first structure configuration may include at least one of the followings: eight PSBCH repetitions, location of each one of the eight PSBCH repetitions, one SLSS, location of the one SLSS, the unoccupied RBs and the location of each one of the unoccupied RBs.

In some embodiments, one SLSS of the at least one of SLSS is at or close to an edge of the S-SSB in the frequency domain. For example, in FIG. 4A, the SLSS is at the edge of the S-SSB.

In some embodiments, one PSBCH repetition of the at least one PSBCH repetition is at or close to one edge of the S-SSB in the frequency domain, and another PSBCH repetition of the at least one PSBCH repetition is at or close to the other edge of the S-SSB in the frequency domain. For example, in FIG. 4B, one PSBCH repetition is at the edge of the S-SSB, and another PSBCH repetition is at the other edge of the S-SSB.

In some embodiments, a total number of the at least one RB and the location of each one of the at least one RB are identical for all symbols in the at least one S-SSB in the slot format. For example, in FIG. 4A, the unoccupied seven RBs are from RB #55 to RB #61 for all the symbols of the S-SSB.

In some embodiments, the first configuration includes a second structure configuration in the frequency domain of a symbol of the at least one symbol of each S-SSB, and the second structure configuration includes at least one of the followings: an interlace pattern in a frequency band, index(es) of available interlace(s) for a S-SSB in the frequency band, at least one interlace for one S-SSB, index(es) of available interlace(s) for a SLSS in the frequency band, at least one interlace for one SLSS, index(es) of available interlace(s) for a PSBCH in the frequency band, or at least one interlace for one PSBCH. For example, in FIG. 7A, for symbol #1, the second structure configuration may include at least one of the followings: an interlace pattern in a frequency band, interlace #0 to interlace #5 are available interlaces for a S-SSB in the frequency band, at least one interlace for one S-SSB, interlace #0 for a SLSS in the frequency band, one interlace for one SLSS, interlace #1 for a PSBCH in the frequency band, or one interlace for one PSBCH.

In some embodiments, the processor is further configured to: select the interlace(s) based on at least one of: random selection, an identifier of the UE, an identifier of a SLSS associated with the UE, or a priority level of synchronization reference of the UE.

In some embodiments, the processor is further configured to: obtain a second configuration associated with the slot format, wherein the second configuration includes at least one of the followings: at least one symbol as a gap for performing an LBT procedure, or location of each one of the at least one symbol. For example, in FIG. 4A, the second configuration may indicate symbol #6 and symbol #13 are considered as gaps for performing an LBT procedure.

In some embodiments, the processor is further configured to: obtain a third configuration associated with the slot format including at least one S-SSB multiplexed with SL data in at least one of a time domain or the frequency domain, wherein the third configuration includes at least one of the followings: location(s) of the SL data in the slot format in the time domain, or location(s) of the SL data in the slot format in the frequency domain. For example, in FIG. 8A, the third configuration may include: all the RBs in the frequency band in symbol #7 to symbol #12 are for transmitting the SL data.

In some embodiments, the processor is further configured to: obtain a fourth configuration associated with the slot format, wherein the fourth configuration includes at least one of the followings: a length of the S-SSB period, at least one S-SSB within the S-SSB period, an offset from a starting slot of the S-SSB period to a first slot containing S-SSB within the S-SSB period, or an interval between two adjacent slots containing S-SSB.

In some embodiments, at least one of the first configuration, the second configuration, the third configuration, or the fourth configuration is configured based on at least one of the following granularities: per channel bandwidth, per carrier, per bandwidth part, per frequency range, or per SCS.

In some embodiments, the first configuration is received via at least one of: a MIB message, a SIB message, a RRC signalling, or a MAC CE.

FIG. 10 illustrates an apparatus for S-SSB transmission in an unlicensed spectrum according to some embodiments of the present disclosure.

As shown in FIG. 10, an example of the apparatus 1000 may include at least one processor 1004 and at least one transceiver 1002 coupled to the processor 1004. The apparatus 1000 may be a UE or a BS or any other device with similar functions.

Although in this figure, elements such as the at least one transceiver 1002 and processor 1004 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1004 may interact with each other so as to perform the operations of the UE described in any of FIGS. 1-9. In some embodiments of the present disclosure, the apparatus 1000 may be a BS. The transceiver 1002 and the processor 1004 may interact with each other so as to perform the operations of the BS described in any of FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1004 to implement the method with respect to the UE as described above. For example, the computer-executable instructions, when executed, cause the processor 1004 interacting with transceiver 1002 to perform the operations of the UE described in any of FIGS. 1-9.

In some embodiments of the present disclosure, the non-transitory computer-readable medium may have stored thereon computer-executable instructions to cause the processor 1004 to implement the method with respect to the BS as described above. For example, the computer-executable instructions, when executed, cause the processor 1004 interacting with transceiver 1002 to perform the operations of the BS described in any of FIGS. 1-9.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE), comprising:
at least one memory; and
at least one processor coupled with the at least one memory and configured to cause the UE to:
obtain a first configuration for sidelink synchronization signal block (S-SSB) in an unlicensed spectrum based on configuration or pre-configuration, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB;
select at least one S-SSB occasion at least based on the first configuration; and
transmit an S-SSB on the at least one S-SSB occasion in response to a listen before talk (LBT) procedure associated with the at least one S-SSB occasion being successful.

2. The UE of claim 1, wherein the first configuration includes a first structure configuration in the frequency domain of a symbol of the at least one symbol of each S-SSB, and the first structure configuration includes at least one of the following:
at least one PSBCH repetition,
location of each one of the at least one PSBCH repetition,
at least one SLSS repetition,
location of each one of the at least one SLSS repetition,
at least one resource block (RB) unoccupied by the at least one PSBCH repetition and/or the at least one SLSS repetition, or
location of each one of the at least one RB in a frequency band.

3. The UE of claim 2, wherein one SLSS repetition of the at least one of SLSS repetition is at or close to an edge of the S-SSB in the frequency domain.

4. The UE of claim 2, wherein one PSBCH repetition of the at least one PSBCH repetition is at or close to one edge of the S-SSB in the frequency domain, and another PSBCH repetition of the at least one PSBCH repetition is at or close to the other edge of the S-SSB in the frequency domain.

5. The UE of claim 2, wherein a total number of the at least one RB and the location of each one of the at least one RB are identical for all symbols in the at least one S-SSB in the slot format.

6. The UE of claim 1, wherein the first configuration includes a second structure configuration in the frequency domain of a symbol of the at least one symbol of each S-SSB, and the second structure configuration includes at least one of the following:
an interlace pattern in a frequency band,
index(es) of available interlace(s) for a S-SSB in the frequency band,
at least one interlace for one S-SSB,
index(es) of available interlace(s) for a SLSS in the frequency band,
at least one interlace for one SLSS,
index(es) of available interlace(s) for a PSBCH in the frequency band, or
at least one interlace for one PSBCH.

7. The UE of claim 6, wherein the at least one processor is configured to cause the UE to:
select the interlace(s) based on at least one of: random selection, an identifier of the UE, an identifier of a SLSS associated with the UE, or a priority level of synchronization reference of the UE.

8. The UE of claim 1, wherein the at least one processor is configured to cause the UE to:
obtain a second configuration associated with the slot format, wherein the second configuration includes at least one of the following:
at least one symbol as a gap for performing an LBT procedure, or
location of each one of the at least one symbol.

9. The UE of claim 1, wherein the at least one processor is configured to cause the UE to:
obtain a third configuration associated with the slot format including at least one S-SSB multiplexed with sidelink (SL) data in at least one of a time domain or the frequency domain, wherein the third configuration includes at least one of the following:
location(s) of the SL data in the slot format in the time domain, or
location(s) of the SL data in the slot format in the frequency domain.

10. The UE of claim 1, wherein the at least one processor is configured to cause the UE to:
obtain a fourth configuration associated with the slot format, wherein the fourth configuration includes at least one of the following:
a length of an S-SSB period,
at least one S-SSB within the S-SSB period,
an offset from a starting slot of the S-SSB period to a first slot containing S-SSB within the S-SSB period, or
an interval between two adjacent slots containing S-SSB.

11. The UE of claim 1, wherein the first configuration is configured based on at least one of the following granularities:
per channel bandwidth,
per carrier,
per bandwidth part,
per frequency range, or
per subcarrier spacing (SCS).

12. The UE of claim 1, wherein the first configuration is received via at least one of: a master information block (MIB) message, a system information block (SIB) message, a radio resource control (RRC) signaling, or a medium access control (MAC) control element (CE).

13. A base station, comprising:
at least one memory; and
at least one processor coupled with the at least one memory and configured to cause the base station to:
transmit a first configuration for sidelink synchronization signal block (S-SSB) in an unlicensed spectrum, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB.

14. The base station of claim 13, wherein the first configuration includes a first structure configuration in the frequency domain of a symbol of the at least one symbol of each S-SSB, and the first structure configuration includes at least one of the following:
at least one PSBCH repetition,
location of each one of the at least one PSBCH repetition,
at least one SLSS repetition,
location of each one of the at least one SLSS repetition,
at least one resource block (RB) unoccupied by the at least one PSBCH repetition and/or the at least one SLSS repetition, or
location of each one of the at least one RB in a frequency band.

15. A method performed by a user equipment (UE), the method comprising:
obtaining a first configuration for sidelink synchronization signal block (S-SSB) in an unlicensed spectrum based on configuration or pre-configuration, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB;
selecting at least one S-SSB occasion at least based on the first configuration; and
transmitting an S-SSB on the at least one S-SSB occasion in response to a listen before talk (LBT) procedure associated with the at least one S-SSB occasion being successful.

16. A processor for wireless communication, comprising:
at least one controller coupled with at least one memory and configured to cause the processor to:
obtain a first configuration for sidelink synchronization signal block (S-SSB) in an unlicensed spectrum based on configuration or pre-configuration, wherein the first configuration for S-SSB is associated with a slot format including at least one S-SSB, and wherein at least one sidelink synchronization signal (SLSS) is multiplexed with at least one physical sidelink broadcast channel (PSBCH) in a frequency domain in at least one symbol of the at least one S-SSB;
select at least one S-SSB occasion at least based on the first configuration; and
transmit an S-SSB on the at least one S-SSB occasion in response to a listen before talk (LBT) procedure associated with the at least one S-SSB occasion being successful.

17. The processor of claim 16, wherein the first configuration includes a first structure configuration in the frequency domain of a symbol of the at least one symbol of each S-SSB, and the first structure configuration includes at least one of the following:
at least one PSBCH repetition,
location of each one of the at least one PSBCH repetition,
at least one SLSS repetition,
location of each one of the at least one SLSS repetition,
at least one resource block (RB) unoccupied by the at least one PSBCH repetition and/or the at least one SLSS repetition, or
location of each one of the at least one RB in a frequency band.

18. The processor of claim 17, wherein one SLSS repetition of the at least one of SLSS repetition is at or close to an edge of the S-SSB in the frequency domain.

19. The processor of claim 17, wherein one PSBCH repetition of the at least one PSBCH repetition is at or close to one edge of the S-SSB in the frequency domain, and another PSBCH repetition of the at least one PSBCH repetition is at or close to the other edge of the S-SSB in the frequency domain.

20. The processor of claim 17, wherein a total number of the at least one RB and the location of each one of the at least one RB are identical for all symbols in the at least one S-SSB in the slot format.
